(19) United States
(12) Patent Application Publication
(10) Pub. No.: US 2009/0107137 A1
(43) Pub. Date: Apr. 30, 2009

(54) Integral power element

(76) Inventors: Kenneth Lionello, Waterbury, CT (US); Kevin W. Lamb, West Hartford, CT (US)

Correspondence Address: ALIX YALE & RISTAS LLP, 750 MAIN STREET, SUITE 1400, HARTFORD, CT, 06103, US

(21) Appl. No.: 11/978,822

(22) Filed: Oct. 30, 2007

(51) Int. Cl. F03G 7/06

(52) U.S. Cl. 60/508; 29/890.124; 60/527

(57) ABSTRACT

A thermal actuator and component part wherein the guide tube of the thermal actuator is integral with the component part. The cup containing the thermally responsive wax is crimped over a flange on the end of the guide tube. An actuating piston is positioned in the guide tube. The component part has a portion having a larger external diameter than the external diameter of the cup. The thermal actuator and component part are assembled by enclosing a split die member about the component part and integral guide tube member, placing the split die member with the component part and tube member into a lower tool member and advancing an upper tool member containing the cup toward the die member to cause the wall of the cup member to be crimped around the flange.

### FIELD OF THE INVENTION

The present invention relates to a thermal actuator, and more particularly, to a thermal actuator of a type wherein a thermally responsive wax actuates a push rod or the like and its attachment to a component part.

### BACKGROUND

Thermal actuators of the type designed to utilize a push rod are well known in the art. U.S. Pat. No. 6,988,364 shows one type of such actuator. The disclosure of this patent is incorporated herein by reference in its entirety.

As shown and described in that patent, the thermal actuator may comprise a cup in which a thermally responsive wax is contained and a guide tube in which an actuating piston is mounted. A plug is positioned on top of the wax in the cup and has an integral diaphragm base that is sealed between a shoulder in the cup and a flange at the bottom of the guide tube. The cup is attached to the guide tube by crimping its upper end over the flange of the guide tube. In operation, upon being subjected to heat, the wax expands and causes the plug to ride up within the relatively narrow guide tube in turn imparting a motion to the piston.

In some versions, the actuators are provided with a threaded portion on the end of the guide tube which is used to threadably connect the actuator to a component part. Such arrangement is generally satisfactory for most applications. However, there are occasions when it is necessary that a threaded actuator stay securely connected to its component part. In such cases, there is concern that the threaded connection between the guide tube of the actuator and the component part may become loose due to vibration or the like and a more secure connection is needed. Accordingly, it is desirable that a thermal actuator be provided that it is unseparable from its component part.

### SUMMARY

According to one aspect a method of making a thermal actuator with an attached component part is provided comprising providing a tool and die arrangement including a first tool member, a second tool member and a split die. A cup containing a thermally responsive wax is inserted into the upper tool member with the opening of the cup facing downwardly. A component part with an integral guide tube extending therefrom is provided, the guide tube having a flange at its free end. A split die is positioned about the component part and the guide tube with the flange of the guide tube extending from the split die, the top of the split die having a counterbore. The split die with the component part and guide tube is inserted into the second tool member. A plug and diaphragm seal are positioned on the guide tube with the plug extending into the guide tube. The first and second tool members are advanced toward each other so that the end of the cup advances over the flange on the guide tube and has its leading edge turned inwardly by the counterbore around the flange of the of the guide tube so that the cup is crimped onto the guide tube with the flange of the guide tube is secured between the inturned leading edge and the diaphragm seal.

According to another aspect there is provided an integral thermal actuator comprising a component part having a portion of a given outer diameter and a guide tube integral with and extending from the component part, the guide tube being of a smaller diameter than the given diameter and having a flange at its free end. A cup having top portion of a given outer diameter and a closed bottom portion is provided, the bottom portion defining a cylindrical cavity filled with a thermally responsive wax, the given outer diameter of the upper portion of the cup being smaller than the given diameter of the component part and the top portion being crimped about the flange of the guide tube to secure cup to the guide tube.

### BRIEF DESCRIPTION OF THE DRAWINGS

FIG. 1 is a side view, partially in section of an actuator and its component part;

FIG. 2 is an exploded sectional side view showing the components of the actuator and component part of FIG. 1;

FIG. 3 is a sectional side view of a tool and die for use in a press for assembling the thermal actuator and component part of FIG. 1;

FIG. 4 is a sectional side view of the tool and die of FIG. 3 showing the second step in the assembly operation in which the parts are inserted into the tool and die;

FIG. 5 is a sectional side view of the tool and die of FIG. 3 showing the next step in the assembly operation wherein the split die is positioned in the bottom of the tool;

FIG. 6 is a sectional side view of the tool and die of FIG. 3 showing the next step in the assembly operation wherein the top tool is descending toward the split die; and

FIG. 7 is a sectional side view of tool and die of FIG. 3 showing the position of the parts at the end of the pressing stroke wherein the cup has been secured to the tube by primping its upper edge.

### DETAILED DESCRIPTION

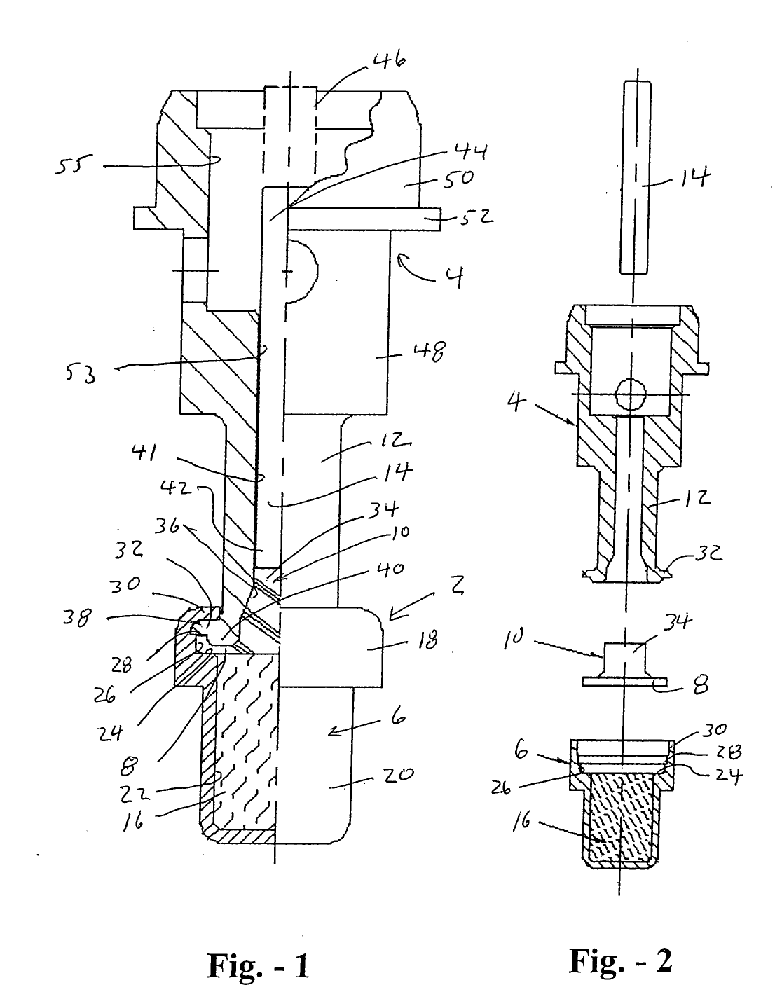

FIG. 1 shows a power element in the form of a thermal actuator 2 and its component part 4. In general the thermal actuator 2 includes a rigid cup 6, a resilient diaphragm wax seal 8, a plug 10, and a guide tube 12 in which an actuating piston 14 is mounted. The bottom of the cup 6 contains a thermally responsive wax 16. It is known that the thermally responsive wax 16 used in thermal actuators can be formulated to expand at a range of temperatures between 30° and 210° F. Thermal expansion as a percentage of the wax volume between possibly 12% and 20% can also be selected by well known wax formulations. The change in temperature or ΔT required to activate the wax is technically between 10° and 20° F.

More particularly, the rigid cup 6 has an open top portion 18, and a closed bottom portion 20. The bottom portion 20 defines a cylindrical cavity 22 of a given diameter which is filled with the thermally responsive wax 16 to an intermediate level within the cup 6. The top portion 18 of the cup includes a first shoulder 24 defined by a first axially extending internal wall portion 26 of a diameter larger than the internal diameter of the cavity 22 in the bottom of the cup 6. The upper end of the first internal wall portion 26 terminates at a second shoulder 28. In the preassembled condition, as shown in FIG. 2, a second wall portion 30 of a larger internal diameter than the first internal wall portion 26 extends axially upward from the second shoulder 28. The first and second wall portions 26 and 30 have a coaxial outer wall of the same diameter that is greater than the outer diameter of the bottom of cup 6. This second wall portion 30 is adapted to be crimped over a flange 32 on the end of the guide tube 12 as shown on FIG. 1 when the various parts a assembled as will be described in greater detail below.

As shown in FIGS. 1 and 2, the plug 10 and diaphragm 8 are formed integrally with each other and may be molded from nitrile rubber or a similar elastomer as a single component. The diaphragm 8 formed at the base of the plug 10 extends over the top of the cavity 22 in which the thermally responsive wax 16 is located. A generally cylindrical stem portion 34 having a diameter less than the diameter of the cavity 22 in the cup 6 in which the thermal wax 16 is positioned extends into the guide tube 12 and assumes the shape of the lower flared internal surface 36 in the end of the guide tube 12.

As previously mentioned, the second wall portion 30 at the upper end of the cup 6 is crimped over the flange 32 of the guide tube 12 to the position as shown in FIG. 1. This radially inward crimp extends over the flange 32 at the bottom of the guide tube 12 and captures the rim 38 of the flange 32 in a notch such that the rim 38 bears against a hard stop defined by the second shoulder 28. During this crimping, a ridge 40 on the bottom of the flange 32 of the guide tube 12 axially compresses the diaphragm 8 thereby extruding a peripheral portion of the diaphragm 8 against the first side wall 26 and filling the space between the first side wall 26 and the outwardly facing lateral surfaces of the ridge 40. This thus provides a radially inner seal of the diaphragm base against the first cup shoulder forming an axial seal. Reference may be made to the aforesaid mentioned U.S. Pat. No. 6,988,364 for a more detailed description of the crimping and sealing arrangement.

The guide tube 12 and the component part 4 are integral elements. As such, the component part 4 and the guide tube 12 are a single component, preferably made of the same material in one-piece and as such they are unseparable. The actuating piston 14 is positioned within a bore 51 in the guide tube 12 as shown as shown with its bottom end 42 positioned against the plug 10 and its upper end 44 extending into the component part. The dotted line 46 represents the travel of the actuating piston 14 as the actuator 2 reaches its operative temperature.

In the particular case shown in FIG. 1, the component part 4 includes a lower body portion 48 having an outer diameter substantially the same as the outer diameter of the top portion 18 of the cup 6. Additionally, the component part 4 also includes a head portion 50 at its upper end separated from the lower body portion 48 by a flange 52. A bore 53 extends through the component part coaxial with the bore 41 in the guide tube 12 with an enlarged counterbore 55 at its upper end. The upper end 44 of the actuating piston 14 is supported in the bore 53 and extends into the counterbore 55. Both the flange 52 and the head portion 50 have an outer diameter greater than the outer diameter of the top portion 18 of the cup 6.

In the case shown, the component part 4 is an element that is adapted to be fit into a tube through which oil flows. The function of the thermal actuator 2 is to control, by temperature, when oil should flow.

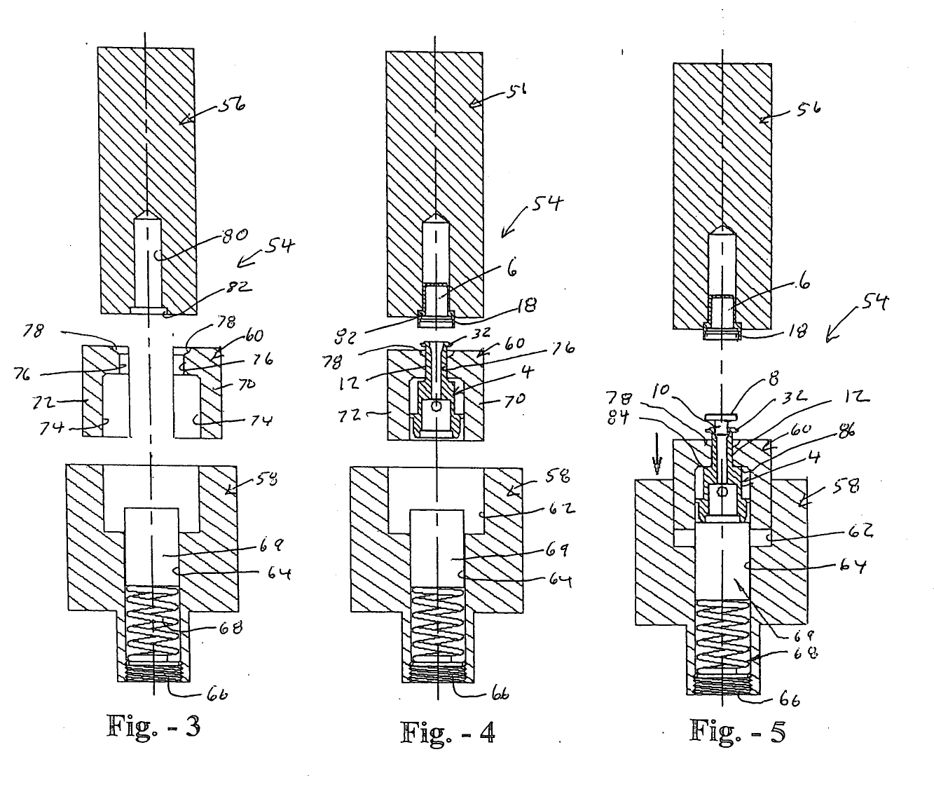

FIG. 3 shows a tool and die arrangement 54 which may be used in a press (not shown) to accomplish the assembly of the actuator 2 and component part 5 with integral guide tube 12 shown in FIG. 1. As shown in FIG. 3, the tool and die arrangement 54 generally includes an upper tool member 56, a lower tool member 58 and an intermediate split die member 60. The lower tool member 58 has an enlarged counterbore 62 extending axially downward from its upper surface and a bore 64 of lesser diameter extending downwardly from the counterbore 62. A threaded plug 66 closes the bottom of the bore 64. A spring member 68 is mounted in the bore 64 and biases in an upward direction a piston 69 which is mounted in the bore 64 and extends into the counterbore 62.

The intermediate split die member 60 is in the form of a two piece sleeve. The two sleeves 70 and 72, when fitted together in contact with each other, have an external diameter such that sleeves 70 and 72 will be received within the counterbore 62 of the lower tool member 58. The intermediate split die member 60 includes an enlarged counterbore 74 extending inwardly from its lower end, a smaller intermediate bore 76 and a curved counterbore 78 extending axially inwardly from its upper end surface. The upper tool member 56 includes an axial bore 80 opening into its bottom surface with a cylindrical counterbore 82 of an enlarged diameter at the opening.

As shown in FIG. 3, the cup 6 is inserted into the bore 80 in the upper tool member 56 with the enlarged top portion 18 of the cup 6 being positioned within the counterbore 82. The open end of the cup 6 is facing downward.

The two sleeves 70 and 72 of the intermediate split die member 60 are placed around the component part 4 with integral guide tube 12 with the component part 4 being received within the enlarged counterbore 74. For this purpose, the enlarged counterbore 74 should have a diameter equal to the largest diameter of the component part 4. The guide tube 12 is positioned in the smaller intermediate bore 76 of the spilt die member 60 with the flange 32 at the end of the guide tube 12 positioned above the curved counterbore 78 as shown.

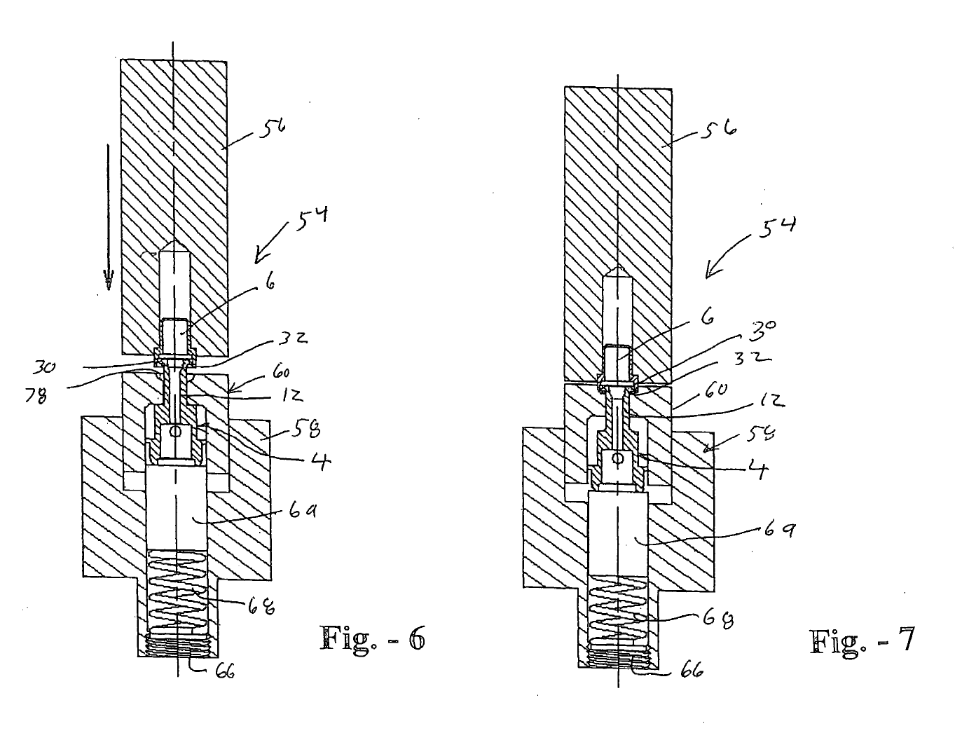

With the two sleeves 70 and 72 placed around the component part 4 and guide tube 12, the split die member 60 is inserted into the enlarged counterbore 62 in the lower tool member 68 as shown in FIG. 5. The plug 10 and integral diaphragm base 8 is placed on top of the flange 32 with the plug extending into the bore 53 in the guide tube 12. The spring member 68 will bias the piston 69 up against the bottom of the component part 4 to bias a shoulder 84 at the juncture of the component part 4 and guide tube 12 against an internal shoulder 86 in the split die member 60 to ensure the component part 4 and guide tube 12 are in proper position.

With the tools positioned in a suitable press (not shown), the upper tool member 56 is advanced toward the lower tool member 58 and split die member 60 as shown in FIG. 6. In so doing, the open end 18 of the cup 6 in the upper tool member 56 will be advanced over the flange 32 on the end of the guide tube 12. The second wall portion 30 of the cup 6 will surround the flange 32 and be forced down into the tapered counterbore 78 in the top of the split die member 60. Continued movement of the upper tool member 56 toward the lower member 58 to the position shown in FIG. 7 will cause the second wall portion 30 of the cup member 6 to collapse about the flange 32 into the position as shown in FIG. 1 whereupon the wall portion 30 is crimped about the flange to complete the closure. The spring member 68 will bias the component part 4 and guide tube 12 upwardly during this phase of the assembly so that the flange 32 on the end of the guide tube 12 is held in engagement with the diaphragm seal 8 in the cup 6.

The use of a split die member 60 enables the component part 4 and the integral guide tube 12 to be held in the lower tool member while the cup 6 is axially moved against the split die member 60 to crimp the wall of the cup 6 about the flange 32 to ensure a good connection and provide the seal with the base portion of the plug as described above.

By virtue of the above described arrangement, a thermal actuator is connected to its component part with the guide tube of the thermal connecter being integral and the cup of the thermal actuator containing a thermally responsive wax being crimped on to the bottom of the tube. This arrangement ensures that the thermal actuator cannot break loose from the component part due to vibration or other movement. Also, the provision of the tool and die assembly as described, enables the cup to be crimped onto the end of a guide tube integrally connected to the component part wherein the component part has an enlarged diameter portion of a diameter greater than the diameter of the sleeve portion of the cup.

While the preferred embodiment has been shown and described, various modifications and substitutions may be made thereto. Accordingly, it is understood that the present embodiment has been described by way of illustration and not limitation.

What is claimed is:

1. A method of making a thermal actuator with an attached component part comprising:
providing a tool and die arrangement including a first tool member, a second tool member and a split die,
inserting a cup containing a thermally responsive wax into the first tool member with the opening of the cup facing outwardly,
providing a component part with an integral guide tube extending therefrom, said guide tube having a flange at its free end,
placing said split die about said component part and said guide tube with the flange of said guide tube extending from said split die, said top of said split die having a counterbore,
inserting said split die with said component part and guide tube into said second tool member,
positioning a plug and diaphragm seal on said guide tube with the plug extending into said guide tube
advancing said first and second tool members toward each other so that the end of the cup advances over said flange on said guide tube and has its leading edge turned inwardly by said counterbore around the flange of the of said guide tube so that said cup is crimped onto said guide tube with said flange of said guide tube is secured between said inturned leading edge and said diaphragm seal.

2. The method of making a thermal actuator with an attached component part of claim 1 further including inserting an actuating piston member in said guide tube through the end of said component part after said cup has been crimped to said guide tube.

3. The method of making a thermal actuator with an attached component part of claim 1 further including biasing said component part and integral guide tube against a shoulder in said split die as said first tool moves toward said second tool during at least the initial advancement of said tool members toward each other.

4. The method of making a thermal actuator with an attached component part of claim 1 further including biasing said component part and integral guide tube toward said first tool member so that said flange is held against said diaphragm seal as said tool members are advanced toward each other.

5. The method of making a thermal actuator with an attached component part of claim 1 wherein said plug and diaphragm seal in said cup are integral.

6. The method of making a thermal actuator with an attached component part of claim 1 wherein said split die member comprises two sleeves, said sleeves being positioned about said component part and said guide tube.

7. An integral thermal actuator comprising:
a component part having a portion of a given outer diameter,
a guide tube integral with and extending from component part, said guide tube being of a smaller diameter than said given diameter and having a flange at its free end,
an actuating piston in said guide tube,
a cup having top portion of a given outer diameter and a closed bottom portion, the bottom portion defining a cylindrical cavity filled with a thermally responsive wax, said given outer diameter of said upper portion of said cup being smaller than said given diameter of said component part,
the top portion being crimped about the flange of said guide tube to secure cup to said guide tube.

8. The integral thermal actuator of claim 7 further including a diaphragm over said wax sealing said wax in said cup and a plug over said diaphragm and extending into said guide tube, said actuating piston in said guide tube having one end positioned against said plug and its other end extending into said component part.

9. The integral thermal actuator of claim 7 wherein said plug and diaphragm are integral.

10. The integral thermal actuator of claim 7 wherein said guide tube and said component part are of the same material.

11. The integral thermal actuator of claim 7 wherein said plug has a diameter smaller than the diameter of the cavity in which said thermally responsive wax is positioned.

12. The integral thermal actuator of claim 7 wherein said component part includes a body portion from which the guide tube extends, an upper cylindrical head portion and a flange separating said body portion from said head portion, the outer diameter of said head portion being greater than the outer diameter of body.
